(19) United States
(12) Patent Application Publication
(10) Pub. No.: US 2007/0165047 A1
(43) Pub. Date: Jul. 19, 2007

(54) Graphic rendering system capable of performing real-time compression and decompression

(75) Inventors: Shin-Chien Wang, Taipei City (TW); Chih-Chung Shih, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/652,626

(22) Filed: Jan. 12, 2007

(30) Foreign Application Priority Data
Jan. 13, 2006 (TW) 095101331

(51) Int. Cl. G09G 5/00

(52) U.S. Cl. 345/582

(57) ABSTRACT

A graphic rendering system capable of performing real-time compression and decompression, which includes a storage device, a decompressor, a rendering engine, a first real-time compressor, a frame buffer and a first real-time decompressor. The storage device stores a compressed sprite image and a compressed background image. The decompressor performs a decompression operation to thereby obtain a sprite image and a background image. The rendering engine performs an image processing on the sprite image and the background image to thereby produce a partial display image. The first real-time compressor performs a real-time compression processing on the partial display image to thereby produce a compressed partial display image. The frame buffer temporarily stores the compressed partial display image. The first real-time decompressor performs a real-time decompression processing on the compressed partial display image to thereby output an image signal for display.

### BACKGROUND OF THE INVENTION

1. Field of the Invention

The invention relates to a graphic rendering system and, more particularly, to a graphic rendering system capable of performing real-time compression and decompression.

2. Description of Related Art

FIG. 1 is a block diagram of a conventional game application platform. As shown, to save computational amount and bandwidth, sprite and background images on a typical 2-D game application platform are normally pre-coded and stored in a memory 110. A decompressor 120 decodes the sprite and background images when the rendering engine 130 is to read them. The rendering engine 130 can accordingly perform an image processing, such as an alpha blending, on the sprite and background images, and store the resulting RGB values in a frame buffer 112. Thus, a display device 140 can read data from the frame buffer 112 for displaying the sprite and background images. Methods applied to code the sprite and background images include variable run length coding, color look-up tables (CLUT), Huffman coding, and the like.

Since the data stored in the frame buffer 112 by the rendering engine 130 is in an RGB form, the image can be further coded. However, in a real-time rendering and display graphic image system, a CLUT is typically used, and thus the data stored in the frame buffer 112 by the rendering engine 130 is not in an RGB form but an index form. In this case, if an image requires 256 colors, corresponding data written in the frame buffer 112 only requires an 8-bit index value. In displaying the image, actual RGB data can be obtained by searching a CLUT in accordance with the index value. The RGB data can be 16 or 24 bits. However, the deficiency of such a way is a limit to color types.

Currently, the rendering engine 130 is designed to be a form of command driving. Therefore, a coding method can be determined only after the rendering engine 130 completely performs an image processing on an entire image, which cannot achieve a dynamic effect. For example, when the rendering engine 130 receives a command to display a sprite on a location {(20, 20)-(39, 39)}, it reads the data of the sprite from the memory 110 and writes the data read to the location {(20, 20)-(39, 39)} of the frame buffer 112. At this point, if another command to display another sprite on a location {(10, 10)-(49, 49)} is received by the rendering engine 130, the previously displayed sprite image is overwritten, which leads to wasting bandwidth because the entire image is compressed and coded only after the rendering engine 130 completely performs an image processing on an entire image. Thus, such a way is not suitable for a real-time rendering and display graphic image system.

In addition, typical MPEG and JPEG methods require a great amount of computation and bandwidth and also are not suitable for real-time rendering and display graphic image system. Further, because the data output of the rendering engine 130 is not compressed, more bandwidth is required to transmit the data to the frame buffer 112. Therefore, the frame buffer 112 and the memory 110 cannot be integrated into the same storage device, which significantly increases the system hardware cost. Accordingly, it is desirable to provide an improved graphic rendering system to mitigate and/or obviate the aforementioned problems.

### SUMMARY OF THE INVENTION

An object of the invention is to provide a graphic rendering system capable of performing real-time compression and decompression, which can save the required bandwidth for a rendering engine to transmit data to a frame buffer and achieve the function of real-time image output to thus reduce the access time to the frame buffer, thereby increasing the entire system performance.

Another object of the invention is to provide a graphic rendering system capable of performing real-time compression and decompression, which can save the size of a frame buffer used to store data transmitted by a rendering engine and achieve the function of real-time image output to thus reduce the hardware cost.

To achieve the objects, there is provided a graphic rendering system capable of performing real-time compression and decompression. The system includes a storage device, a decompressor, a rendering engine, a first real-time compressor, a frame buffer and a first real-time decompressor. The storage device stores one or more compressed sprite images and one or more compressed background images. The decompressor is connected to the storage device and performs a decompression operation on the one or more compressed sprite images and background images respectively to thereby obtain one or more sprite images and background images respectively. The rendering engine is connected to the decompressor and performs an image processing on the one or more sprite and background images to thereby produce a partial display image. The first real-time compressor is connected to the rendering engine and performs a real-time compression processing on the partial display image to thereby produce a compressed partial display image. The frame buffer is connected to the first real-time compressor and temporarily stores the compressed partial display image. The first real-time decompressor is connected to the frame buffer and performs a real-time decompression processing on the compressed partial display image to thereby output an image signal for display.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a conventional game application platform;

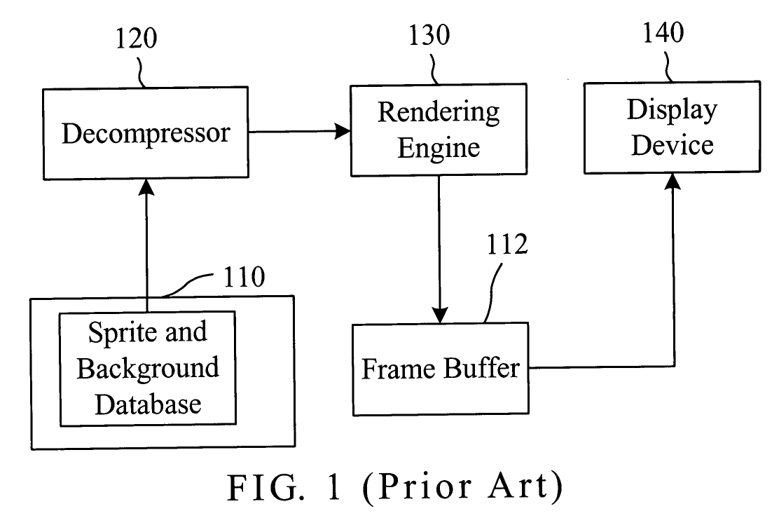

FIG. 2 is a block diagram of a graphic rendering system capable of performing real-time compression and decompression in accordance with the invention;

FIG. 3 is a schematic view of a sprite data structure in accordance with the invention;

FIG. 4 is a schematic view of an image processing performed by a rendering engine in accordance with the invention;

FIG. 5 is a schematic view of a golomb-rice coding operation in accordance with the invention;

FIG. 6 is a schematic view of a format of compressed data in accordance with the invention; and

FIG. 7 is a block diagram of a graphic rendering system capable of performing real-time compression and decompression in accordance with another embodiment of the invention.

### DETAILED DESCRIPTION OF THE PREFERRED EMBODIMENT

The invention relates to a graphic rendering system capable of performing real-time compression and decompression. When an image processing is performed completely by a rendering engine, a plurality of pixels processed by the image processing is compressed in real-time, so as to save the required bandwidth for a rendering engine to transmit data to a frame buffer and achieve the function of real-time image output. Thus, the access time to the frame buffer is reduced, and the entire system performance is increased.

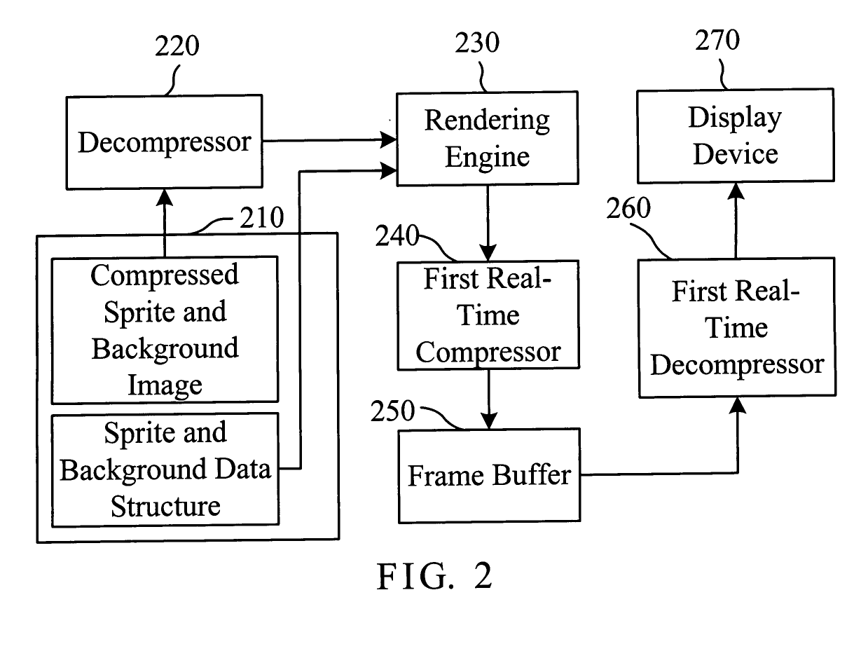

FIG. 2 is a block diagram of a graphic rendering system capable of performing real-time compression and decompression in accordance with the invention. As shown, the system includes a storage device 210, a decompressor 220, a rendering engine 230, a first real-time compressor 240, a frame buffer 250, a first real-time decompressor 260 and a display device 270.

As shown in FIG. 2, the storage device 210 stores one or more compressed sprite images and one or more compressed background images. The decompressor 220 is connected to the storage device 210 and performs a decompression operation on the one or more compressed sprite and background images to thereby obtain one or more sprite and background images.

The rendering engine 230 is connected to the decompressor 220 and performs an image processing on the one or more sprite and background images to thereby produce a partial display image. The first real-time compressor 240 is connected to the rendering engine 230 and performs a real-time compression processing on the partial display image to thereby produce a compressed partial display image.

The frame buffer 250 is connected to the first real-time compressor 240 and temporarily stores the compressed partial display image. The first real-time decompressor 260 is connected to the frame buffer 250 and performs a real-time decompression processing on the compressed partial display image to thereby output an image signal for display. The display device 270 is connected to the first real-time decompressor 260 and displays the image signal output by the first real-time decompressor 260.

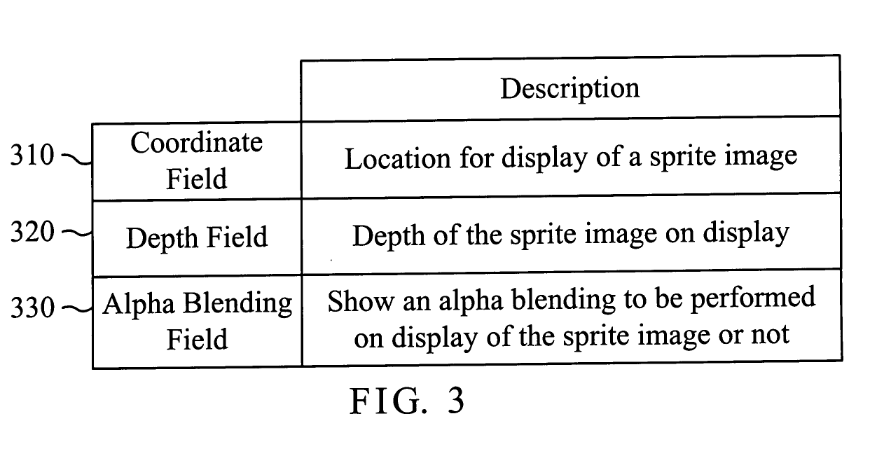

The storage device 210, in addition to storing the compressed sprite and background images, stores a sprite data structure. FIG. 3 is a schematic view of the sprite data structure. As shown, the data structure includes a coordinate field 310, a depth field 320 and an alpha blending field 330.

The coordinate field 310 records a location for a sprite image display. The depth field 320 records a depth of the sprite image display. The alpha blending field 330 records a state to show whether an alpha blending is performed on the sprite image display or not.

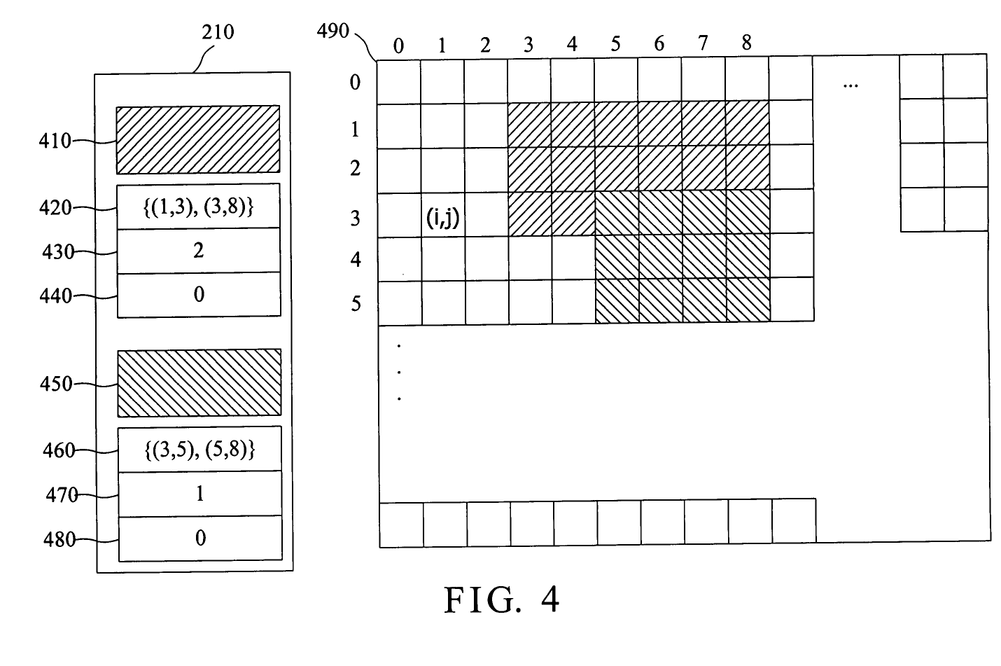

FIG. 4 is a schematic view of an image processing performed by a rendering engine in accordance with the invention. As shown in FIG. 4, the storage device 210 stores an compressed image 410 and associated data structure information 420-440 of a sprite A, and an compressed image 450 and associated data structure information 460-480 of a sprite B. For processing a pixel (i, j) of a display image 490, the rendering engine 230 first determines if the pixel (i, j) is located in a sprite image. Namely, the rendering engine 230 compares the pixel (i, j) with the coordinate information 420 of the sprite A and the coordinate information 460 of the sprite B. For example, a pixel (0, 0) is not within the coordinates 420 and 460, and accordingly the rendering engine 230 extracts a background image for use as an image data of the pixel (0, 0). A pixel (1, 3) is within the coordinate 420 of the sprite A and not within the coordinate 460 of the sprite B, and accordingly the rendering engine 230 extracts the sprite image of the sprite A for use as an image data of the pixel (1, 3). Further, a pixel (3, 5) is within the coordinates 420 and 460, but the depth information 470 (which is 1) of the sprite B is is smaller than the depth information 430 (which is 2) of the sprite A, and accordingly the rendering engine 230 extracts the sprite image of the sprite B for use as an image data of the pixel (3, 5).

When processing the pixel (1, 3), the rendering engine 230 extracts an image corresponding to the sprite A for use as an image data of the pixel (1, 3) because the alpha blending information 440 of the sprite A contains zero. If the alpha blending information 440 of the sprite A contains one, the rendering engine 230 performs an alpha blending on the image corresponding to the sprite A and a background image. Thus, an image data obtained after the alpha blending is used as an image data of the pixel (1, 3).

The rendering engine 230 performs the image processing on eight pixels every time and sends the eight pixels to the first real-time compressor 240.

The first real-time compressor 240 performs the Hadamard transform on the eight pixels to thereby obtain corresponding frequency domain values of the pixels. The Hadamard transform is given in equation (1) as follows:

$$[ \begin{matrix}1 & 1 & 1 & 1 & 1 & 1 & 1 & 1 \\ 1 & 1 & 1 & 1 & - 1 & - 1 & - 1 & - 1 \\ 1 & 1 & - 1 & - 1 & - 1 & - 1 & 1 & 1 \\ 1 & 1 & - 1 & - 1 & 1 & 1 & - 1 & - 1 \\ 1 & - 1 & - 1 & 1 & 1 & - 1 & - 1 & 1 \\ 1 & - 1 & - 1 & 1 & - 1 & 1 & 1 & - 1 \\ 1 & - 1 & 1 & - 1 & - 1 & 1 & - 1 & 1 \\ 1 & - 1 & 1 & - 1 & 1 & - 1 & 1 & - 1\end{matrix} ] [ \begin{matrix}p 0 \\ p 1 \\ p 2 \\ p 2 \\ p 4 \\ p 5 \\ p 6 \\ p 7\end{matrix} ] = [ \begin{matrix}h 0 \\ h 1 \\ h 2 \\ h 3 \\ h 4 \\ h 5 \\ h 6 \\ h 7\end{matrix} ] , \qquad ( 1 )$$

where p0˜p7 represent the respective pixel values of the eight pixels, and h0˜h7 represent the respective frequency domain values of the eight pixels. The notation h0 is regarded as a DC term while the notations h1˜h7 are regarded as AC terms. When the display image 490 is in an RGB format, the notations p0˜p7 indicate an R, G, or B value of the eight pixels respectively. When the display image 490 is in a YUV format, the notations p0˜p7 indicate a Y, U, or V value of the eight pixels respectively.

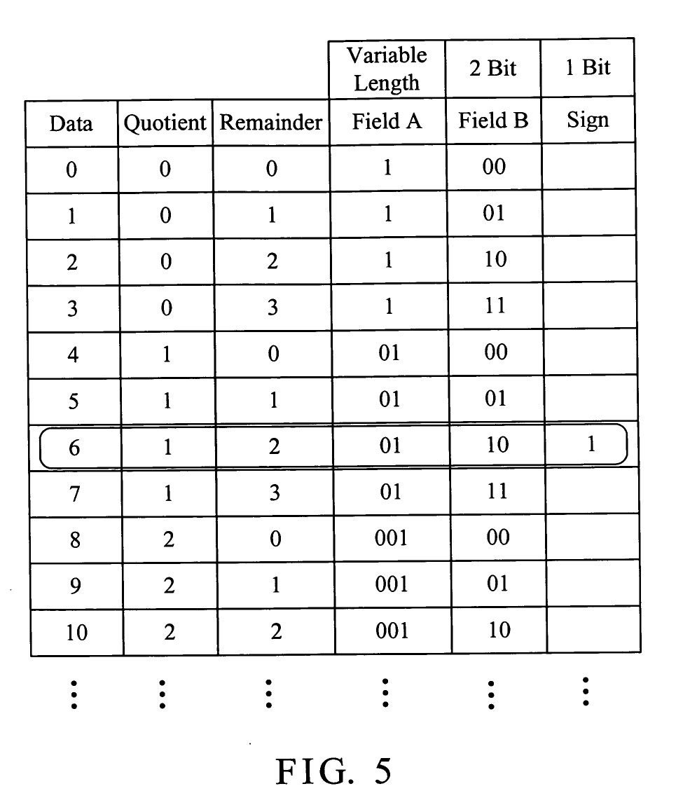

The first real-time compressor 240 further performs a golomb-rice coding operation on h1˜h7. FIG. 5 is a schematic view of the golomb-rice coding operation in accordance with the invention. For example, as shown in FIG. 5, for h1=−6, the golomb-rice coding operation divides six by four to thereby obtain a quotient of one and a remainder of two. A field B is “10” because the remainder equals two, and a field A is “01” because the quotient equals one. In addition, the sign field is “1” to indicate the minus sign of the h1 value. In this case, after the golomb-rice coding, h1=−6 can be represented in a binary form of 01101_{b} If the quotient equals two, the field A becomes “001”; if the quotient equals three, the field A becomes “0001”; and so on.

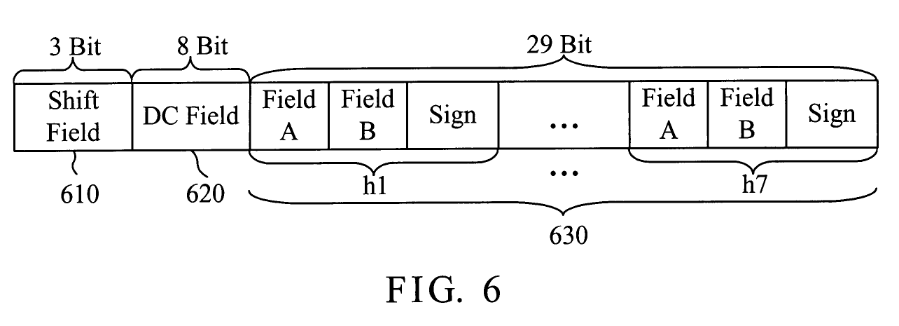

The first real-time compressor 240 is based on h0 and data obtained after the golomb-rice coding to produce a compressed data corresponding to the eight pixels p0˜p7. FIG. 6 is a schematic view of a format of the compressed data in accordance with the invention. The DC term h0 is recorded in the DC field 620 with eight bits while the AC terms h1˜h7 have values close to zero and are recorded in the AC field 630 with 29 bits after the golomb-rice coding.

If h1˜h7 after the golomb-rice coding require a bit number greater than 29 bits and cannot be recorded in the AC field 630, they are shifted right by one, i.e., the combined value of h1˜h7 is divided by two, and subsequently the golomb-rice coding is applied to h1˜h7 shifted by one. In this case, the shift field 610 records 001_{b} to indicate that h1˜h7 are shifted right by one. If h1˜h7 are shifted right by one and cannot be recorded in the AC field 630, they are shifted right by two, i.e., the combined value of h1˜h7 is divided by four, and subsequently the golomb-rice coding is applied to h1˜h7 shifted by two. The operation cited above is repeated until the compressed data obtained by the golomb-rice coding can be recorded in the 29-bit AC field 630.

The first real-time compressor 240 writes the compressed data in the format of FIG. 6 to the frame buffer 250. When displaying, the first real-time decompressor 260 reads the compressed data from the frame buffer 250 and performs a golomb-rice decoding operation on the compressed data read to thereby obtain the frequency domain values h1˜h7 corresponding to the pixels.

When decompressing, if a field A shown in FIG. 6 contains “1”, it indicates that hi (i=1-7) corresponding to the field A occupies four bits in the compressed data and has a size equal to the product of P and Q, where P is the value of the field B and Q is the value of the shift field. If the field A shown in FIG. 6 contains “01”, it indicates that hi (i=1-7) corresponding to the field A occupies five bits in the compressed data and has a size equal to the product of R and S, where R is four plus the value of the field B and S is the value of the shift field. If the field A shown in FIG. 6 contains “001”, it indicates that hi (i=1-7) corresponding to the field A occupies six bits in the compressed data and has a size equal to the product of T and U, where T is 4×2 plus the value of the field B and U is the value of the shift field. Accordingly, the frequency domain values h1˜h7 corresponding to the plurality of pixels are obtained.

The first real-time decompressor 260 performs an inverse Hadamard transform on the frequency domain values h0˜h7 to thereby obtain the respective pixel values p0˜p7. The inverse Hadamard transform is given in equation (2) as follows.

$$\frac{1}{8} [ \begin{matrix}1 & 1 & 1 & 1 & 1 & 1 & 1 & 1 \\ 1 & 1 & 1 & 1 & - 1 & - 1 & - 1 & - 1 \\ 1 & 1 & - 1 & - 1 & - 1 & - 1 & 1 & 1 \\ 1 & 1 & - 1 & - 1 & 1 & 1 & - 1 & - 1 \\ 1 & - 1 & - 1 & 1 & 1 & - 1 & - 1 & 1 \\ 1 & - 1 & - 1 & 1 & - 1 & 1 & 1 & - 1 \\ 1 & - 1 & 1 & - 1 & - 1 & 1 & - 1 & 1 \\ 1 & - 1 & 1 & - 1 & 1 & - 1 & 1 & - 1\end{matrix} ] [ \begin{matrix}h 0 \\ h 1 \\ h 2 \\ h 2 \\ h 4 \\ h 5 \\ h 6 \\ h 7\end{matrix} ] = [ \begin{matrix}p 0 \\ p 1 \\ p 2 \\ p 3 \\ p 4 \\ p 5 \\ p 6 \\ p 7\end{matrix} ] . \qquad ( 2 )$$

The first real-time decompressor 260 uses the inverse Hadamard transform to obtain the pixel values p0˜p7 in spatial domain and sends the pixel values p0˜p7 to the display device 270 for display.

In this embodiment, the storage device 210 and the frame buffer 250 can be separated memories or integrated into a same memory.

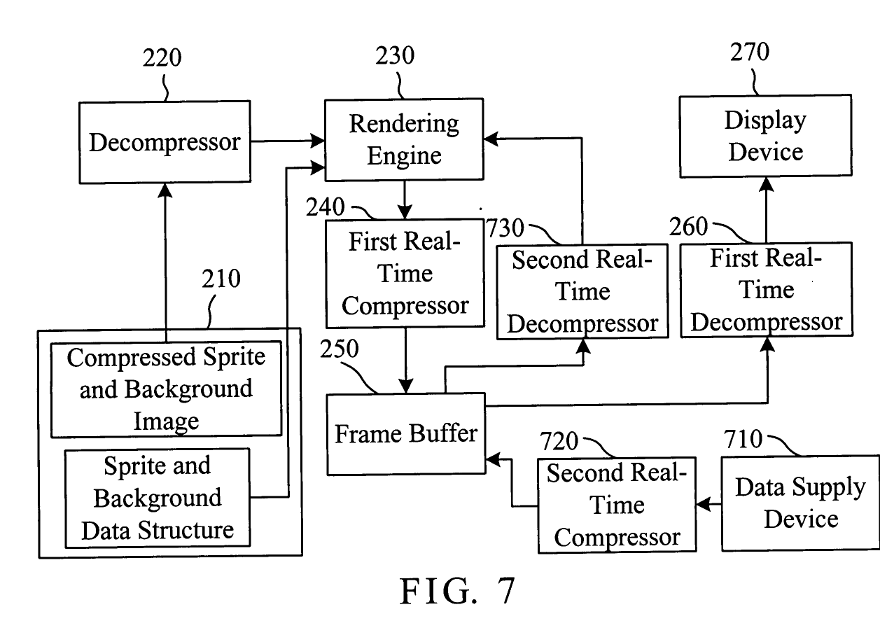

FIG. 7 is a block diagram of another embodiment, which, as compared to the graphic rendering system of FIG. 2, adds a data supply device 710, a second real-time compressor 720 and a second real-time decompressor 730.

The data supply device 710 provides the data of an object image and can be a CCD or CMOS type image capture device.

The second real-time compressor 720 is connected to the data supply device 710 in order to perform a real-time-compression processing on the object image and store the object image compressed in the frame buffer 250. The second real-time decompressor 730 is connected to the frame buffer 250 and performs a real-time decompression processing on the object image compressed to thereby obtain the object image. The rendering engine 230 is connected to the second real-time decompressor 730 and superimposes the object image onto the display image.

In view of the foregoing, it is known that the invention uses the first real-time compressor 240 to perform the real-time compression on the plurality of pixels after the rendering engine 230 performs the image processing to thereby save data amount sent to the frame buffer 250 and further reduce access bandwidth and hardware requirement to the frame buffer 250. In summary, the invention can provide the following three significant advantages. First, as compared to the prior art, less bandwidth is used to send the data to frame buffer 250 because the output of the rendering engine 230 is compressed, and the first real-time decompressor 260 performs the real-time decompression to achieve the function of real-time image output. Second, the data amount is relatively reduced because the output of the rendering engine is compressed, and thus the access time to the frame buffer 250 is reduced and the performance of the entire system is increased. Third, the associated data is reduced and the hardware required for the frame buffer is reduced, which allow the frame buffer 250 and the storage device 210 to be integrated into a same memory, thereby reducing the system hardware cost.

Although the present invention has been explained in relation to its preferred embodiment, it is to be understood that many other possible modifications and variations can be made without departing from the spirit and scope of the invention as hereinafter claimed.

What is claimed is:

1. A graphic rendering system capable of performing real-time compression and decompression, comprising:
a storage device, for storing one or more compressed sprite images and one or more compressed background images;
a decompressor, connected to the storage device, for performing a decompression operation on the one or more compressed sprite images and background images to thereby obtain one or more sprite images and background images respectively;
a rendering engine, connected to the decompressor, for performing an image processing on the one or more sprite images and background images to thereby produce a partial display image;
a first real-time compressor, connected to the rendering engine, for performing a real-time compression processing on the partial display image to thereby produce a compressed partial display image;
a frame buffer, connected to the first real-time compressor, for temporarily storing the compressed partial display image; and
a first real-time decompressor, connected to the frame buffer, for performing said real-time decompression processing on the compressed partial display image to thereby output an image signal for display.

2. The system as claimed in claim 1, further comprising a display device, connected to the first real-time decompressor, for displaying the image signal output by the first real-time decompressor.

3. The system as claimed in claim 1, wherein the storage device further stores a data structure of the one or more sprite images.

4. The system as claimed in claim 3, wherein the data structure comprises a coordinate field, a depth field and an alpha blending field.

5. The system as claimed in claim 4, wherein the coordinate field records a location for display of the one or more sprite images.

6. The system as claimed in claim 4, wherein the depth field records a depth of the one or more sprite images on display.

7. The system as claimed in claim 4, wherein the alpha blending field records a state to show whether the one or more sprite images are performed an alpha blending on display or not.

8. The system as claimed in claim 1, wherein the rendering engine performs an alpha blending on the one or more sprite images and the one or more background images.

9. The system as claimed in claim 1, wherein the first real-time compressor performs a Hadamard transform on a plurality of pixels from the partial display image to thereby obtain a plurality of frequency domain values corresponding to the plurality of pixels respectively.

10. The system as claimed in claim 9, wherein the first real-time compressor performs a golomb-rice coding operation on the plurality of frequency domain values to thereby obtain a compressed data corresponding to the plurality of pixels and store the compressed data in the frame buffer.

11. The system as claimed in claim 10, wherein the first real-time decompressor performs an inverse golomb-rice decoding operation on the compressed data to thereby obtain the plurality of frequency domain values corresponding to the plurality of pixels.

12. The system as claimed in claim 11, wherein the first real-time decompressor performs an inverse Hadamard transform on the plurality of frequency domain values to thereby obtain a plurality of pixel values corresponding to the plurality of pixels respectively.

13. The system as claimed in claim 12, wherein the plurality of pixels is eight pixels.

14. The system as claimed in claim 1, wherein the storage device and the frame buffer are separated memories.

15. The system as claimed in claim 14, wherein the storage device and the frame buffer are integrated in a memory.

16. The system as claimed in claim 2, further comprising:
a data supply device, which provides data of an object image;
a second real-time compressor, connected to the data supply device, for performing the real-time compression processing on the object image to thereby obtain a compressed object image and store the compressed object image in the frame buffer; and
a second real-time decompressor, connected to the frame buffer, for performing the real-time decompression processing on the compressed object image to thereby obtain the object image.

17. The system as claimed in claim 16, wherein the rendering engine is connected to the second real-time decompressor and superimposes the object image onto the partial display image.

18. The system as claimed in claim 17, wherein the data supply device is an image extractor.

19. The system as claimed in claim 18, wherein the image extractor is a CCD type image capture device.

20. The system as claimed in claim 18, wherein the image extractor is a CMOS type image capture device.
